(19) United States
(12) Patent Application Publication
(10) Pub. No.: US 2025/0293628 A1
(43) Pub. Date: Sep. 18, 2025

(54) MOTOR DRIVE DEVICE, MOTOR SYSTEM, AND VEHICLE

(71) Applicant: ROHM CO., LTD., Kyoto-shi (JP)

(72) Inventor: Masato NISHINOUCHI, Kyoto-shi (JP)

(21) Appl. No.: 19/225,352

(22) Filed: Jun. 2, 2025

Related U.S. Application Data
(63) Continuation of application No. PCT/JP2023/040058, filed on Nov. 7, 2023.

(30) Foreign Application Priority Data
Dec. 9, 2022 (JP) 2022-196920

(51) Int. Cl. H02P 29/024

(52) U.S. Cl. CPC H02P 29/024

(57) ABSTRACT

In the present invention, an abnormality detection unit comprises first voltage divider resistors connected between a first external terminal and a second external terminal, second voltage divider resistors connected between the second external terminal and a ground potential application end, first switches connected between the first external terminal and the second external terminal, second switches connected between the second external terminal and the ground potential application end, first comparators configured to compare the voltage between the first external terminal and the second external terminal with first reference voltages, and second comparators configured to compare the voltage between the second external terminal and the ground potential application end with second reference voltages.

### CROSS REFERENCE TO RELATED APPLICATIONS

This application is a continuation under 35 U.S.C. § 120 of PCT/JP2023/040058 filed on Nov. 7, 2023, which is incorporated herein by reference, and which claimed priority to Japanese Patent Application No. 2022-196920 filed on Dec. 9, 2022. The present application likewise claims priority under 35 U.S.C. § 119 to Japanese Application No. 2022-196920, filed Dec. 9, 2022, the entire content of which is also incorporated herein by reference.

### TECHNICAL FIELD

The present disclosure relates to a motor drive device.

### BACKGROUND ART

Conventionally, there have been known motor drive devices configured to drive various types of motors. For example, a motor drive device which drives a brush-equipped DC motor drives the motor with use of a circuit called H-bridge circuit. The H-bridge circuit consists of two half bridges. A half bridge includes a high-side transistor and a low-side transistor connected in series between an application end of a power supply voltage and an application end of ground potential. It is noted that a motor drive device using an H-bridge circuit is disclosed in Patent Document 1 as an example.

### CITATION LIST

### Patent Literature

Patent Document 1: JP 2018-207769 A

### BRIEF DESCRIPTION OF DRAWINGS

FIG. 1 is a diagram showing a configuration of a motor system according to an illustrative embodiment of the present disclosure;

FIG. 2 is a diagram showing an example of short detection operation;

FIG. 3 is a timing chart showing an example of short detection operation;

FIG. 4 is a diagram showing a modification of short detection operation;

FIG. 5 is a diagram showing an example of short detection operation under a motor-disconnected condition (a short of a first high-side transistor);

FIG. 6 is a diagram showing an example of short detection operation under a motor-disconnected condition (a short of a second high-side transistor);

FIG. 7 is a diagram showing a modification of short detection operation under a motor-disconnected condition (a short of the first high-side transistor);

FIG. 8 is a diagram showing a modification of short detection operation under a motor-disconnected condition (a short of the second high-side transistor);

FIG. 9 is a diagram showing an example of short detection operation (shorts of a low-side transistor);

FIG. 10 is a diagram showing a modification of short detection operation (shorts of the low-side transistor);

FIG. 11 is a diagram showing an example of open detection operation;

FIG. 12 is a timing chart showing an example of open detection operation;

FIG. 13 is a diagram showing a modification of open detection operation;

FIG. 14 is a diagram showing open detection operation under a motor-disconnected condition;

FIG. 15 is a diagram showing an example of open detection operation (an open of the low-side transistor;

FIG. 16 is a diagram showing a modification of open detection operation (an open of the low-side transistor);

FIG. 17 is a diagram showing open detection operation under a motor-disconnected condition (an open of the low-side transistor);

FIG. 18 is a diagram showing an operation of detecting an open of wiring for motor connection;

FIG. 19 is an appearance view showing a configuration example of a vehicle on which the motor system is mounted;

FIG. 20 is a diagram showing a configuration of a motor system according to a comparative example;

FIG. 21 is a diagram showing a short detection operation of the motor system according to the comparative example (under a normal condition); and

FIG. 22 is a diagram showing a short detection operation of the motor system according to the comparative example (under a short-occurring condition).

### DESCRIPTION OF EMBODIMENTS

Hereinafter, an illustrative embodiment of the present disclosure will be described with reference to the accompanying drawings.

### 1. Comparative Example

First, a comparative example intended for contrast will be described before describing an embodiment of the disclosure. Description of the comparative example will make issues more clarified.

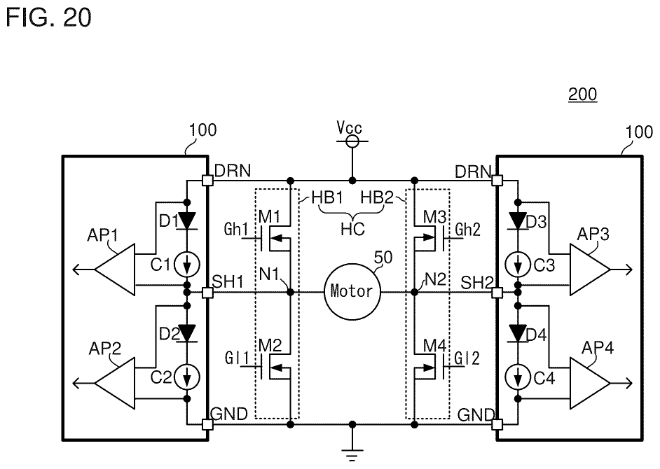

FIG. 20 is a diagram showing a configuration of a motor system 200 according to the comparative example. The motor system 200 includes a motor drive device 100, an H-bridge circuit HC, and a motor 50. The motor drive device 100 drives the motor 50 with use of the H-bridge circuit HC. The motor 50 is a brush-equipped DC motor.

The H-bridge circuit HC includes a first half bridge HB1 and a second half bridge HB2. The first half bridge HB1 includes a first high-side transistor M1 and a first low-side transistor M2 which are connected in series between an application end of a power supply voltage Vcc and an application end of ground potential. More specifically, the first high-side transistor M1 consisting of an N-channel MOSFET (metal-oxide-semiconductor field-effect transistor) has its drain connected to the application end of the power supply voltage Vcc. The first high-side transistor M1 has its source connected at a first node N1 to the drain of the first low-side transistor M2 consisting of an N-channel MOSFET. The source of the first low-side transistor M2 is connected to the application end of ground potential.

The second half bridge HB2 includes a second high-side transistor M3 and a second low-side transistor M4 which are connected in series between an application end of the power supply voltage Vcc and an application end of ground potential. More specifically, the second high-side transistor M3 consisting of an N-channel MOSFET has its drain connected to the application end of the power supply voltage Vcc. The second high-side transistor M3 has its source connected at a second node N2 to the drain of the second low-side transistor M4 consisting of an N-channel MOSFET. The source of the second low-side transistor M4 is connected to the application end of ground potential.

The motor 50 is connected between the first node N1 and the second node N2.

The first high-side transistor M1 is driven by a first high-side gate signal Gh1 applied to the gate of the first high-side transistor M1. More specifically, when the first high-side gate signal Gh1 is at high level, the first high-side transistor M1 is in on status; when the first high-side gate signal Gh1 is at low level, the first high-side transistor M1 is in off status.

The first low-side transistor M2 is driven by a first low-side gate signal Gl1 applied to the gate of the first low-side transistor M2. More specifically, when the first low-side gate signal Gl1 is at high level, the first low-side transistor M2 is in on status; when the first low-side gate signal Gl1 is at low level, the first low-side transistor M2 is in off status.

The second high-side transistor M3 is driven by a second high-side gate signal Gh2 applied to the gate of the second high-side transistor M3. More specifically, when the second high-side gate signal Gh2 is at high level, the second high-side transistor M3 is in on status; when the second high-side gate signal Gh2 is at low level, the second high-side transistor M3 is in off status.

The second low-side transistor M4 is driven by a second low-side gate signal Gl2 applied to the gate of the second low-side transistor M4. More specifically, when the second low-side gate signal Gl2 is at high level, the second low-side transistor M4 is in on status; when the second low-side gate signal Gl2 is at low level, the second low-side transistor M4 is in off status.

The motor drive device 100 includes an unshown transistor drive unit (gate driver) configured to output the gate signals Gh1, Gl1, Gh2, and Gl2. In addition, in FIG. 20, the motor drive device 100 is depicted in right-and-left divisions, which are of one identical device, for convenience' sake.

The motor drive device 100 has, as external terminals functioning to establish electrical connections with outside, a DRN terminal (drain terminal), an SH1 terminal (first high-side source terminal), an SH2 terminal (second high-side source terminal), and a GND terminal (ground terminal). The DRN terminal is connected to the application end of the power supply voltage Vcc. The SH1 terminal is connected to the first node N1. The SH2 terminal is connected to the second node N2. The GND terminal is connected to the application end of ground potential.

The motor drive device 100 includes a diode D1, a constant current source C1, and an amplifier AP1 in ways commensurate with the first high-side transistor M1. The anode of the diode D1 is connected to the DRN terminal. The constant current source C1 is connected between the cathode of the diode D1 and the SH1 terminal. A first input end of the amplifier AP1 is connected to the DRN terminal. A second input end of the amplifier AP1 is connected to the SH1 terminal. Thus, the amplifier AP1 outputs Vds (a drain-source voltage) 1 of the first high-side transistor M1 as it is amplified.

The motor drive device 100 includes a diode D2, a constant current source C2, and an amplifier AP2 in ways commensurate with the first low-side transistor M2. The anode of the diode D2 is connected to the SH1 terminal. The constant current source C2 is connected between the cathode of the diode D2 and the GND terminal. A first input end of the amplifier AP2 is connected to the SH1 terminal. A second input end of the amplifier AP2 is connected to the GND terminal. Thus, the amplifier AP2 outputs Vds2 of the first low-side transistor M2 as it is amplified.

The motor drive device 100 includes a diode D3, a constant current source C3, and an amplifier AP3 in ways commensurate with the second high-side transistor M3. The anode of the diode D3 is connected to the DRN terminal. The constant current source C3 is connected between the cathode of the diode D3 and the SH2 terminal. A first input end of the amplifier AP3 is connected to the DRN terminal. A second input end of the amplifier AP3 is connected to the SH2 terminal. Thus, the amplifier AP3 outputs Vds3 of the second high-side transistor M3 as it is amplified.

The motor drive device 100 includes a diode D4, a constant current source C4, and an amplifier AP4 in ways commensurate with the second low-side transistor M4. The anode of the diode D4 is connected to the SH2 terminal. The constant current source C4 is connected between the cathode of the diode D4 and the GND terminal. A first input end of the amplifier AP4 is connected to the SH2 terminal. A second input end of the amplifier AP4 is connected to the GND terminal. Thus, the amplifier AP4 outputs Vds4 of the second low-side transistor M4 as it is amplified.

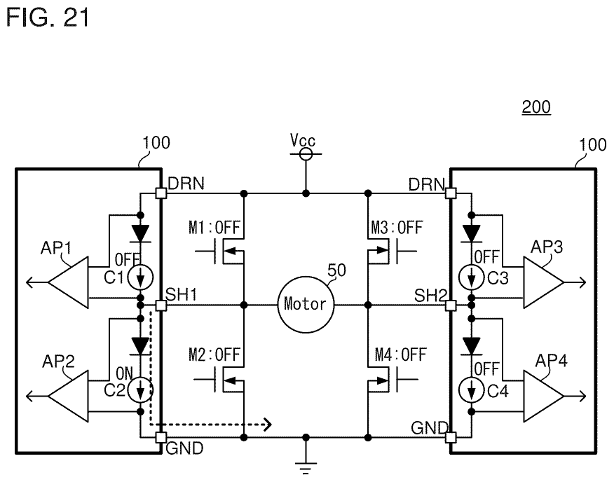

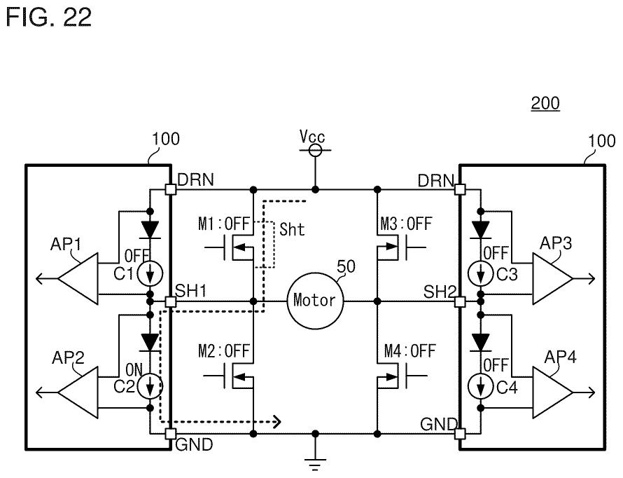

In the motor drive device 100, the diodes D1 to D4, the constant current sources C1 to C4, and the amplifiers AP1 to AP4 as described above are provided to detect any abnormalities of the transistors M1 to M4. As an example, short detection of the first high-side transistor M1 will be described below with reference to FIGS. 21 and 22.

For short detection of the first high-side transistor M1, as shown in FIG. 21, the transistors M1 to M4 are all set to off status, the constant current sources C1, C3 and C4 are set to off status, and the constant current source C2 is set to on status. When no short failure has occurred to the first high-side transistor M1 as shown in FIG. 21, charges are pulled out by the constant current source C2 as indicated by broken line, causing the voltage of the SH1 terminal to come to ground potential. Therefore, the first high-side transistor M1 comes to have a Vds1=DRN terminal voltage (Vcc), so that Vds1 goes to high level.

On the other hand, when a short Sht has occurred to the first high-side transistor M1 as shown in FIG. 22, a current flows through the application end of the power supply voltage Vcc, the first high-side transistor M1, the SH1 terminal, the constant current source C2, and the GND terminal as indicated by broken line. Thus, it holds that SH1 terminal voltage=DRN terminal voltage (Vcc), with a result of Vds1=0. That is, Vds1 goes to low level.

As explained above, short detection for the first high-side transistor M1 can be achieved by referring to the level of Vds1. Also, for short detection of the other transistors M2 to M4, setting the constant current sources C1, C3, C4 to on status allows short detection to be achieved likewise by referring to the levels of Vds2, Vds3, and Vds4.

With the motor system 200 according to the above-described comparative example, since short detection is fulfilled by setting to off status all the transistors M1 to M4 composing the half bridges HB1 and HB2, the motor 50 does not need to be operated to fulfill short detection. However, the constant current sources C1 to C4 are needed in the motor drive device 100. Accordingly, high withstand-voltage elements are needed, leading to increases in circuit size. Also, during short detection, the constant current sources C1 to C4 need to be operated one by one.

### <2. Configuration of Motor System>

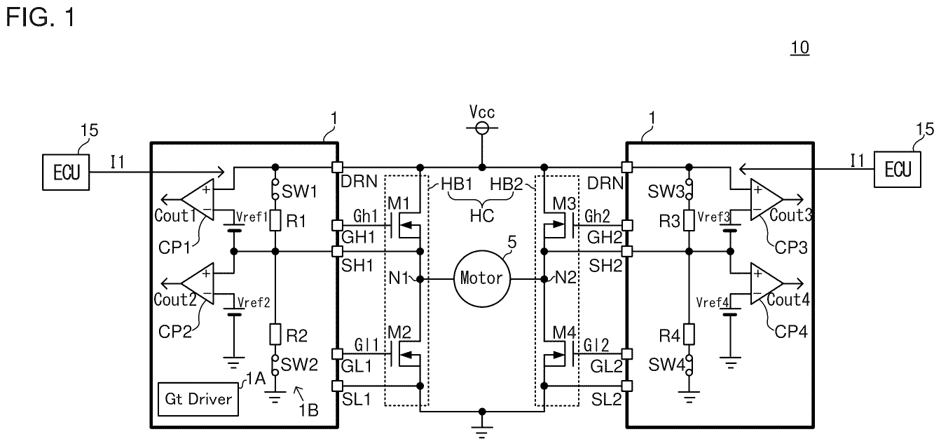

In view of the above-described problems, an embodiment of the present disclosure described below is carried out. FIG. 1 is a diagram showing a configuration of a motor system 10 according to an illustrative embodiment of the disclosure. The motor system 10 includes a motor drive device 1, an H-bridge circuit HC, a motor 5, and an ECU (Electronic Control Unit) 15. The motor system 10 is mountable on a vehicle. The motor system of this disclosure may be applied to consumer use, as an example, without being limited to on-vehicle use.

The H-bridge circuit HC has a configuration similar to that of the above-described comparative example (FIG. 20), so its detailed description is omitted. The motor 5 is connected between the first node N1 and the second node N2. The motor 5 is a brush-equipped DC motor. The transistors M1 to M4 may be internally provided in the motor drive device 1 without being limited to external setting to the motor drive device 1 as shown in FIG. 1.

The motor drive device 1 is a semiconductor device having an IC (integrated circuit) in which an internal configuration shown by FIG. 1 is integrated. It is noted that in FIG. 1 and later-described individual figures, the motor drive device 1 is depicted as right-and-left divisions of one identical device for convenience' sake.

The motor drive device 1 has, as external terminals, a DRN terminal (drain terminal), a GH1 terminal (first high-side gate terminal), an SH1 terminal (first high-side source terminal), a GL1 terminal (first low-side gate terminal), an SL1 terminal (first low-side source terminal), a GH2 terminal (second high-side gate terminal), an SH2 terminal (second high-side source terminal), a GL2 terminal (second low-side gate terminal), and an SL2 terminal (second low-side source terminal).

The DRN terminal is connected to an application end of the power supply voltage Vcc. The GH1 terminal is connected to the gate of the first high-side transistor M1. The SH1 terminal is connected to the source of the first high-side transistor M1. The GL1 terminal is connected to the gate of the first low-side transistor M2. The SL1 terminal is connected to the source of the first low-side transistor M2. The GH2 terminal is connected to the gate of the second high-side transistor M3. The SH2 terminal is connected to the source of the second high-side transistor M3. The GL2 terminal is connected to the gate of the second low-side transistor M4. The SL2 terminal is connected to the source of the second low-side transistor M4.

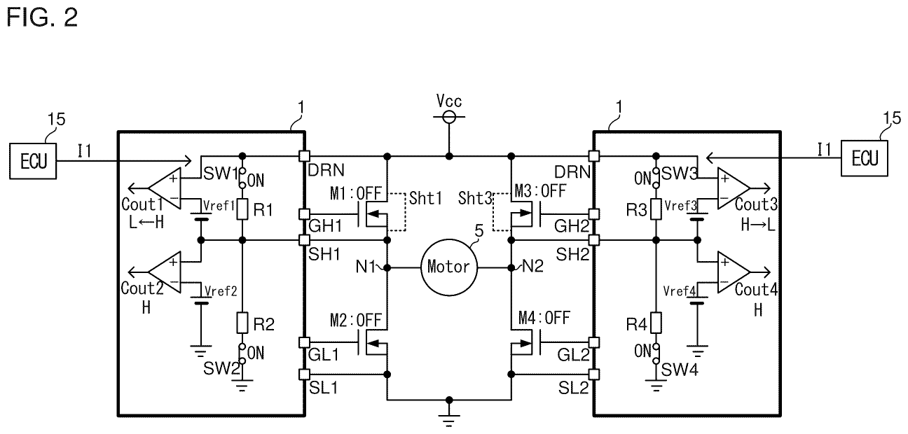

The motor drive device 1 includes a transistor drive unit (gate driver) 1A (not shown for convenience in FIG. 2 and followings). The transistor drive unit 1A outputs a first high-side gate signal Gh1 via the GH1 terminal to the gate of the first high-side transistor M1, outputs a first low-side gate signal Gl1 via the GL1 terminal to the gate of the first low-side transistor M2, outputs a second high-side gate signal Gh2 via the GH2 terminal to the gate of the second high-side transistor M3, and outputs a second low-side gate signal Gl2 via the GL2 terminal to the gate of the second low-side transistor M4, to drive the transistors M1 to M4.

The motor drive device 1 includes an abnormality detection unit 1B. The abnormality detection unit 1B, as will be detailed later, is enabled to perform short/open detection of the transistors M1 to M4 as well as open detection of wiring involved in connection of the motor 5. The abnormality detection unit 1B further includes voltage divider resistors R1 to R4, switches SW1 to SW4, and comparators CP1 to CP4.

The voltage divider resistors R1 and R2, the switches SW1 and SW2, and the comparators CP1 and CP2 are provided in ways commensurate with the first half bridge HB1. The switch SW1 and the resistor R1 are connected in series between the DRN terminal and the SH1 terminal. The resistor R2 and the switch SW2 are connected in series between the SH1 terminal and the application end of ground potential.

A first input end of the comparator CP1 is connected to the DRN terminal. A second input end of the comparator CP1 is connected to an application end of a reference voltage Vref1 with an SH1 terminal voltage assumed as a reference. Thus, the comparator CP1 outputs a result of comparison between Vds1 of the first high-side transistor M1 and the reference voltage Vref1 as a comparison output Cout1.

A first input end of the comparator CP2 is connected to the SH1 terminal. A second input end of the comparator CP2 is connected to an application end of a reference voltage Vref2 with ground potential assumed as a reference. Thus, the comparator CP2 outputs a result of comparison between Vds2 of the first low-side transistor M2 and the reference voltage Vref2 as a comparison output Cout2.

The voltage divider resistors R3 and R4, the switches SW3 and SW4, and the comparators CP3 and CP4 are provided in ways commensurate with the second half bridge HB2. The switch SW3 and the resistor R3 are connected in series between the DRN terminal and the SH2 terminal. The resistor R4 and the switch SW4 are connected in series between the SH2 terminal and the application end of ground potential.

A first input end of the comparator CP3 is connected to the DRN terminal. A second input end of the comparator CP3 is connected to an application end of a reference voltage Vref3 with an SH2 terminal voltage assumed as a reference. Thus, the comparator CP3 outputs a result of comparison between Vds3 of the second high-side transistor M3 and the reference voltage Vref3 as a comparison output Cout3.

A first input end of the comparator CP4 is connected to the SH2 terminal. A second input end of the comparator CP4 is connected to an application end of a reference voltage Vref4 with ground potential assumed as a reference. Thus, the comparator CP4 outputs a result of comparison between Vds4 of the second low-side transistor M4 and the reference voltage Vref4 as a comparison output Cout4.

The switches SW1 to SW4 are on/off controlled by an unshown switch control unit provided in the motor drive device 1. The switch control unit switches over the switches SW1 to SW4 all to on status or all to off status in response to a switch control instruction I1 outputted from the ECU 15. When the switches SW1 to SW4 are set all to on status, there go valid a first voltage divider circuit in which a DRN terminal voltage (Vcc) is divided by the voltage divider resistors R1 and R2, as well as a second voltage divider circuit in which a DRN terminal voltage is divided by the voltage divider resistors R3 and R4. In addition, the switches may be provided more than four in quantity on condition that the SH1 terminal and the SH2 terminal can be disconnected from the DRN terminal and the application end of ground potential.

Furthermore, the voltage divider resistors R1 to R4 have such resistance values that R1=R2 and R3=R4, which are enough larger than a resistance value of the motor 5. Thus, it becomes possible to reduce power consumption due to currents flowing through the resistors R1 and R2 as well as currents flowing through the resistors R3 and R4 on condition that the first voltage divider circuit and the second voltage divider circuit are valid.

### <3. Short Detection>

Next, abnormality detection operation by the motor drive device 1 will be described. First, short detection of the transistors M1 to M4 by the motor drive device 1 is explained.

### <3-1. Short Detection of High-Side Transistor>

For short detection operation, as shown in FIG. 2, all the transistors M1 to M4 are set to off status, and all the switches SW1 to SW4 are set to on status. In a normal case where no shorts have occurred to the transistors M1 to M4, dividing the DRN terminal voltage (Vcc) by the voltage divider resistors R1 and R2 yields an SH1 terminal voltage=DRN/2. Since the reference voltages Vref1 and Vref2 have been set lower than DRN/2, comparison outputs Cout1 and Cout2 both go to high level.

Also in the normal case, dividing the DRN terminal voltage by the voltage divider resistors R3 and R4 yields an SH2 terminal voltage=DRN/2. Since the reference voltages Vref3 and Vref4 have been set lower than DRN/2, comparison outputs Cout3 and Cout4 both go to high level.

On the other hand, as shown in FIG. 2, in a case where a short Sht1 has occurred to the first high-side transistor M1, it holds that SH1 terminal voltage=DRN terminal voltage, causing Vds1=0. Therefore, the comparison output Cout1 goes to low level, and the comparison output Cout2 goes to high level. Under this condition, it follows via the motor 5 that SH2 terminal voltage=DRN terminal voltage, causing Vds3=0. Therefore, the comparison output Cout3 goes to low level. The comparison output Cout4 goes to high level.

Further, as shown in FIG. 2, in a case where a short Sht3 has occurred to the second high-side transistor M3 as well, the comparison outputs Cout1 to Cout4 go to the same level as in the case where a short has occurred to the first high-side transistor M1. Therefore, since Cout1 and Cout3 are changed over from high to low level in contrast to the normal case, it can be detected that a short has occurred to the high-side transistor M1 or M3.

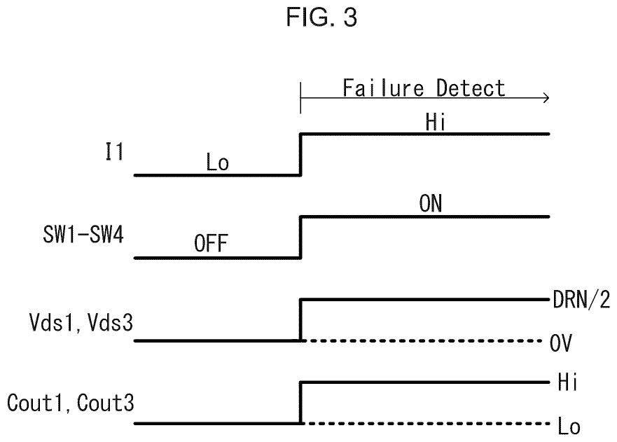

FIG. 3 is a timing chart showing such short detection operation as described above. FIG. 3 shows, in descending order starting with the uppermost stage, a switch control instruction I1, on/off status of the switches SW1 to SW4, Vds1 and Vds3, Cout1 and Cout3. When the switch control instruction I1 is changed over from low to high level, the abnormality detection operation gets started, with the switches SW1 to SW4 changed over to on status. In this state, given a normal case, it holds that Vds1=Vds3=DRN/2, causing Cout1 and Cout3 to go to high level. Given a short-occurring case, it follows that Vds1=Vds3=0, causing Cout1 and Cout3 to go to low level.

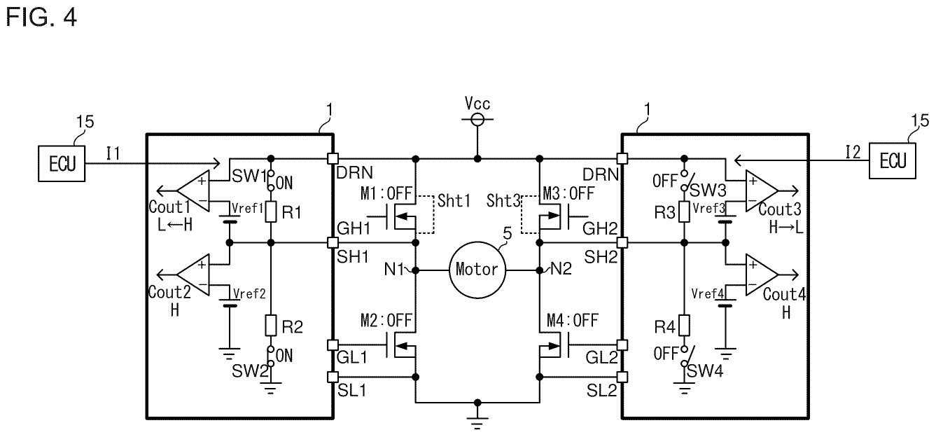

FIG. 4 is a diagram showing a modification of the short detection operation. In this case, the switches SW1 and SW2 are on/off controlled by the switch control instruction I1 outputted from the ECU 15, while the switches SW3 and SW4 are on/off controlled by a switch control instruction 12 outputted from the ECU 15. That is, a couple of switches SW1 and SW2 and another couple of switches SW3 and SW4 can be on/off controlled independently of each other.

In the state shown in FIG. 4, the switches SW1 and SW2 are set to on status, and the switches SW3 and SW4 are set to off status. Also, by such short detection operation, like the foregoing case of FIG. 2, all of Cout1 to Cout4 go to high level under a normal condition, whereas a case in which a short has occurred to either one of the high-side transistors M1 and M3 involves transition of Cout1 and Cout3 to low level in contrast to the normal case.

Given such a condition of FIG. 4, since the switches SW3 and SW4 have been set to off status, power consumption due to currents flowing through the resistors R3 and R4 can be reduced. Also in FIG. 2, when the short Sht1 of the first high-side transistor M1 has occurred, a current flows through an application end of the power supply voltage Vcc, the first high-side transistor M1, the motor 5, the SH2 terminal, and the voltage divider resistor R4. However, since the voltage divider resistor R4 has been set enough larger in resistance value than the motor 5, the above-mentioned current is small in magnitude. Thus, operation of the motor 5 can be reduced. In addition, since the condition of FIG. 4 involves setting the voltage divider resistor R4 to off status, the above-mentioned current becomes naught, so that operation of the motor 5 can be reduced to more extent.

Alternatively, it is allowable that, in FIG. 4, the switches SW1 and SW2 are set to off status while the switches SW3 and SW4 are set to on status.

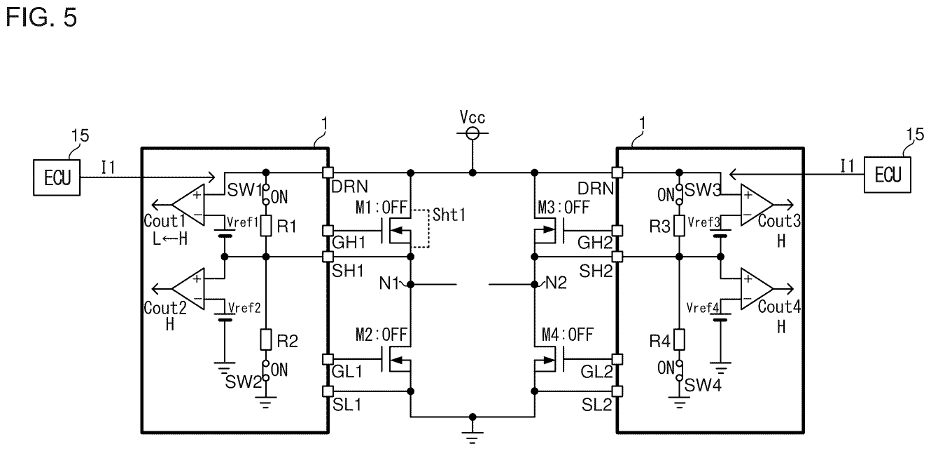

FIG. 5 is a diagram showing short detection operation under a motor 5-disconnected state. In this case, states of the transistors M1 to M4 and the switches SW1 to SW4 are the same as those of FIG. 2. Under this condition, the comparison outputs Cout1 to Cout4 all go to high level under a normal condition. On the other hand, as shown in FIG. 5, when a short Sht1 of the first high-side transistor M1 has occurred, the comparison output Cout1 is changed to low level in contrast to the normal-condition case.

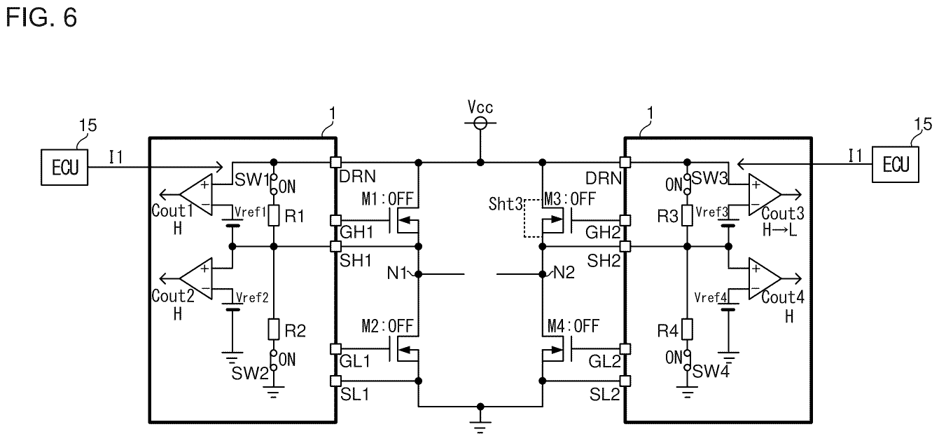

Meanwhile, as shown in FIG. 6, when a short Sht3 has occurred to the second high-side transistor M3, Cout3 is changed to low level in contrast to the normal-condition case. Thus, with the motor 5 disconnected, which one of the high-side transistors M1 and M3 the short has occurred to can be specifically determined.

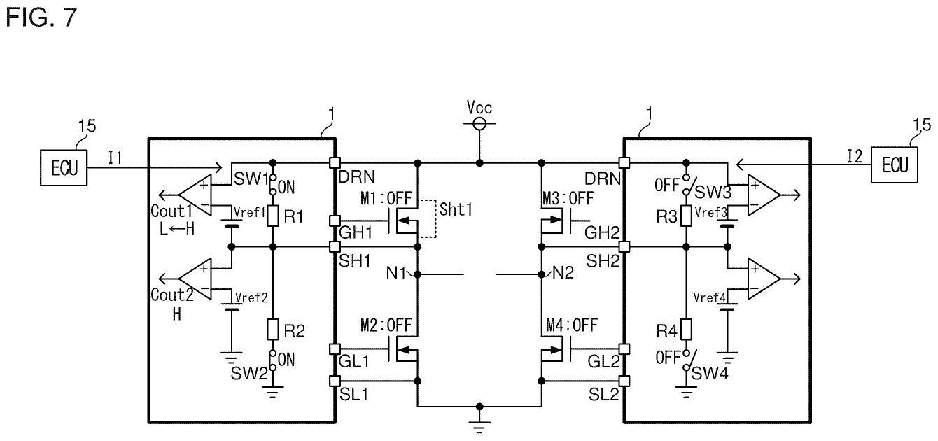

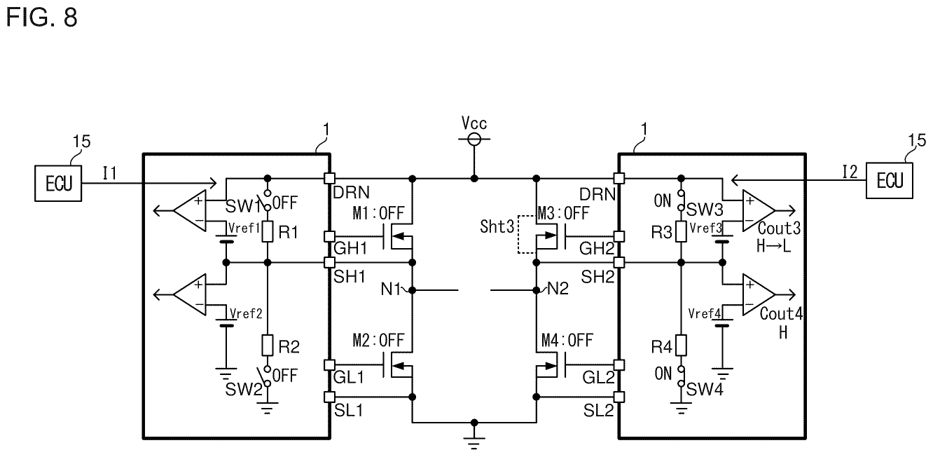

FIGS. 7 and 8 are diagrams showing modifications of the short detection operation under a motor 5-disconnected state. In FIG. 7, the switches SW1 and SW2 are set to on status while the switches SW3 and SW4 are set to off status. In this case, Cout1 and Cout2 go to high level under a normal condition. On the other hand, when a short Sht1 has occurred to the first high-side transistor M1, Cout1 is changed to low level in contrast to the normal-condition case.

Also in FIG. 8, the switches SW1 and SW2 are set to off status while the switches SW3 and SW4 are set to on status. In this case, Cout3 and Cout4 go to high level under a normal condition. On the other hand, when a short Sht3 has occurred to the second high-side transistor M3, Cout3 is changed to low level in contrast to the normal-condition case.

Thus, a short of the first high-side transistor M1 can be detected by the level of Cout1 under the condition of FIG. 7. Under the condition of FIG. 8, a short of the second high-side transistor M3 can be detected by the level of Cout3. Further, since either one couple out of a couple of the switches SW1, SW2 and another couple of the switches SW3, SW4 is set to off status, power consumption can be reduced.

### <3-2. Short Detection of Low-Side Transistor>

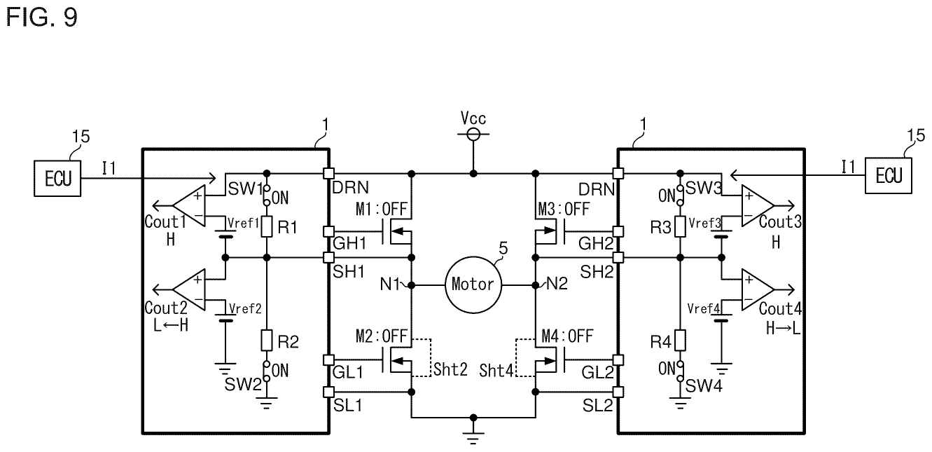

FIG. 9 is a diagram showing short detection operation similar to that of FIG. 2. That is, the transistors M1 to M4 are set to off status while the switches SW1 to SW4 are set to on status. Under this condition, when a short Sht2 has occurred to the first low-side transistor M2 as shown in FIG. 9, it holds that SH1 terminal voltage=0, causing Cout2 to be changed to low level in contrast to the normal-condition case. Under this condition, it results via the motor 5 that SH2 terminal voltage=0, causing Cout4 to be changed to low level in contrast to the normal-condition case. Also, when a short Sht4 has occurred to the second low-side transistor M4, Cout2 and Cout4 undergo level change as in the case where the short has occurred to the first low-side transistor M2.

Thus, by the level change of Cout2 and Cout4, it can be detected that a short has occurred to either one of the low-side transistors M2 and M4.

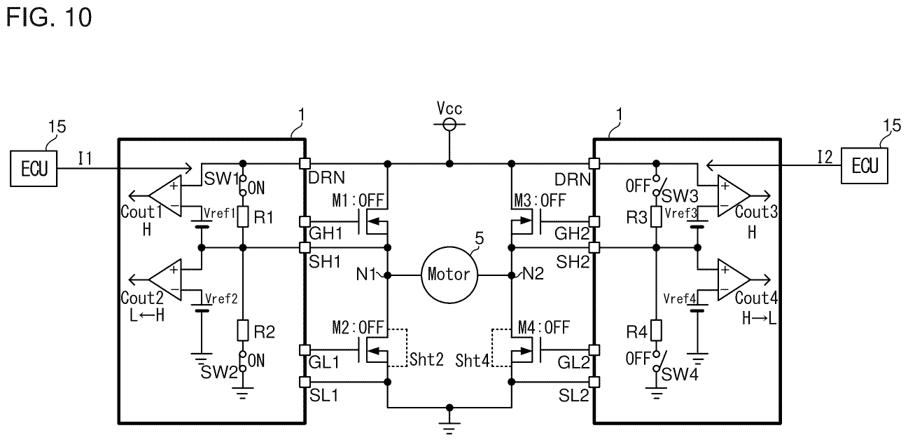

FIG. 10 is a diagram showing short detection operation similar to that of FIG. 4. That is, the transistors M1 to M4 are set to off status, the switches SW1 and SW2 are set to on status, and the switches SW3 and SW4 are set to off status. In this case, when a short has occurred to the low-side transistor M2 or M4, Cout2 and Cout4 undergo level change.

Under the above-described condition of FIG. 10, since the switches SW3 and SW4 are in off status, power consumption can be reduced. Further, when a short Sht2 has occurred to the first low-side transistor M2, the voltage divider resistor R3's being in off status causes reduction of a current flowing via the motor 5 to the first low-side transistor M2, so that operation of the motor 5 can be reduced.

Furthermore, even by short detection operation under such motor 5-disconnected states as shown in FIG. 5 to FIG. 8, which either one of the low-side transistors M2 and M4 a short has occurred to can be specifically determined.

### <4. Open Detection>

Next, open detection of the transistors M1 to M4 by the motor drive device 1 will be described below.

### <4-1. Open Detection of High-Side Transistor>

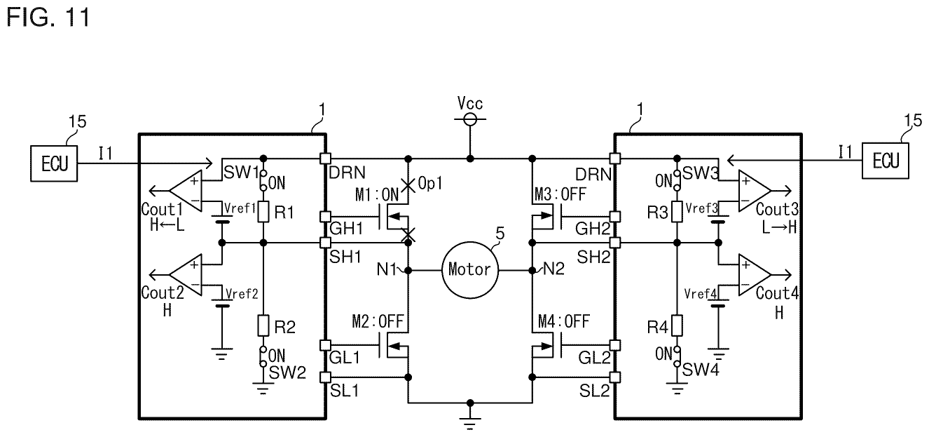

For open detection of the first high-side transistor M1, as shown in FIG. 11, the first high-side transistor M1 is set to on status, the other transistors M2 to M4 are set to off status, and the switches SW1 to SW4 are set all to on status. On condition that the transistors M1 to M4 are normally functional in this state, it holds that SH1 terminal voltage=DRN terminal voltage, causing Vds1=0. Therefore, Cout1 goes to low level. Under this condition, it holds that Vds2=DRN, causing Cout2 to go to high level. Further, it follows via the motor 5 that SH2 terminal voltage=DRN, causing Vds3=0, Vds4=DRN. Consequently, Cout3 goes to low level, and Cout4 goes to high level.

Meanwhile, as shown in FIG. 11, when an open Op1 has occurred to the first high-side transistor M1, it holds that SH1 terminal voltage=DRN/2. Therefore, it follows that Vds1=Vds2=DRN/2, causing Cout1 and Cout2 to go to high level. Under this condition, SH2 terminal voltage=DRN/2. Consequently, it holds that Vds3=Vds4=DRN/2, causing Cout3 and Cout4 to go to high level. Thus, an open of the first high-side transistor M1 can be detected by a change to high level of Cout1 and Cout3 in contrast to the normal-condition case.

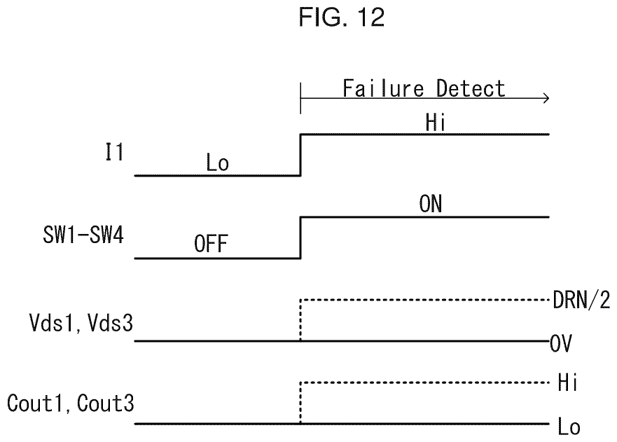

FIG. 12 is a timing chart showing such open detection operation as described above. FIG. 12 shows, in descending order starting with the uppermost stage, a switch control instruction I1, on/off status of the switches SW1 to SW4, Vds1 and Vds3, Cout1 and Cout3. When the switch control instruction I1 is changed over from low to high level, the abnormality detection operation gets started, with the switches SW1 to SW4 changed over to on status. On condition that In this state, given a normal-condition case, it holds that Vds1=Vds3=0, causing Cout1 and Cout3 to go to low level. Given a open-occurring case, it follows that Vds1=Vds3=DRN/2, causing Cout1 and Cout3 to go to high level.

In addition, in FIG. 11, on condition that the first high-side transistor M1 is set to off status and the second high-side transistor M3 is set to on status, it becomes possible to detect an open of the second high-side transistor M3.

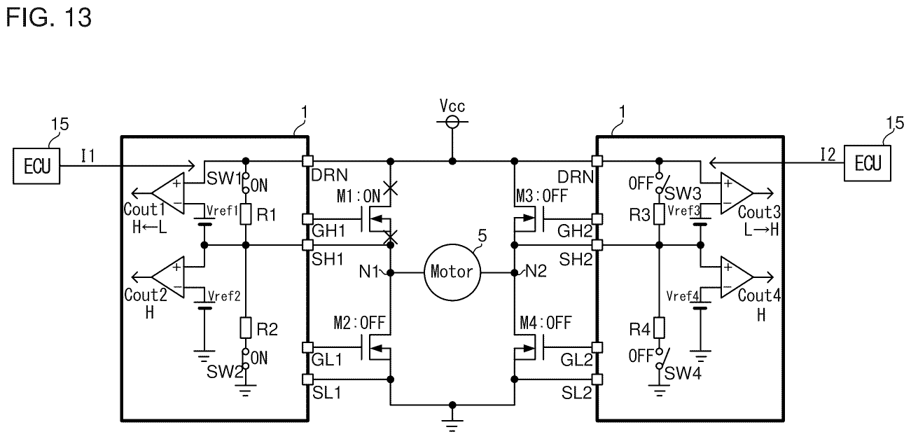

FIG. 13 is a diagram showing a modification of the open detection operation shown in FIG. 11. A difference from FIG. 11 in this case is that the switches SW3 and SW4 are set to off status. As a result, although an open of the first high-side transistor M1 can be detected by level change of Cout1 and Cout3 as in the case of FIG. 11, yet power consumption can be reduced. Further, although a current flows through the application end of the power supply voltage Vcc, the first high-side transistor M1 of on status, the motor 5, the SH2 terminal, and the voltage divider resistor R4 under a normal condition in FIG. 11, yet the current is small in magnitude because of a resistance value of the voltage divider resistor R4 being set enough larger than the resistance value of the motor 5. Accordingly, operation of the motor 5 can be reduced. In addition, in the state of FIG. 13, by the voltage divider resistor R4 being set to off status, the above-mentioned current becomes zero, so that operation of the motor 5 can be reduced to more extent.

Furthermore, for open detection of the second high-side transistor M3, it is appropriate that, in FIG. 13, the first high-side transistor M1 is set to off status, the second high-side transistor M3 is set to on status, the switches SW1 and SW2 are set to off status, and the switches SW3 and SW4 are set to on status. Thus, a current flowing to the voltage divider resistor R2 via the second high-side transistor M3 and the motor 5 under a normal condition becomes zero, so that operation of the motor 5 can be reduced.

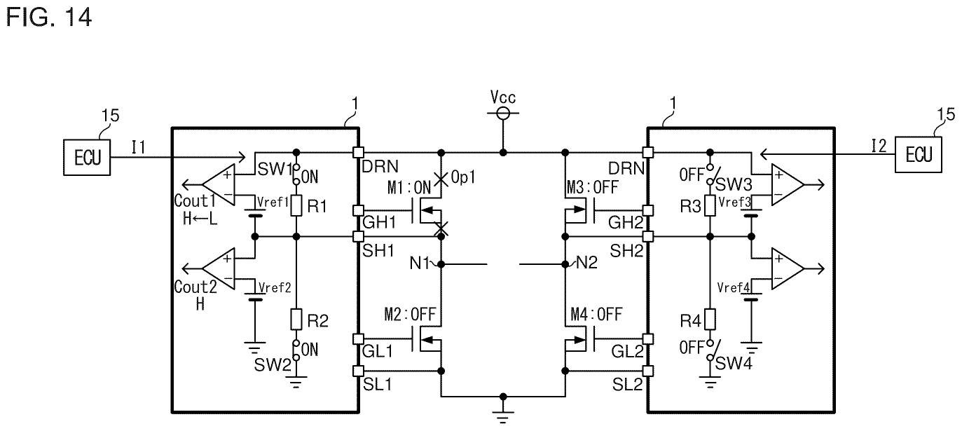

FIG. 14 is a diagram showing open detection operation of the first high-side transistor M1 under a motor 5-disconnected state. In this case, the first high-side transistor M1 is set to on status, the other transistors M2 to M4 are set to off status, and the switches SW1 and SW2 are set to on status. As a result, Cout1 goes to low level and Cout2 goes to high level under a normal condition. On the other hand, when an open Op1 has occurred to the first high-side transistor M1, Cout1 and Cout2 go to high level. Accordingly, an open of the first high-side transistor M1 can be detected by level change of Cout1 as compared with that under the normal condition. In this case, as shown in FIG. 14, setting the switches SW3 and SW4 to off status allows power consumption to be reduced.

In addition, for open detection of the second high-side transistor M3, it is appropriate that, in FIG. 14, the first high-side transistor M1 is set to off status, the second high-side transistor M3 is set to on status, the switches SW3 and SW4 are set to on status, and the switches SW1 and SW2 are set to off status.

### <4-2. Open Detection of Low-Side Transistor>

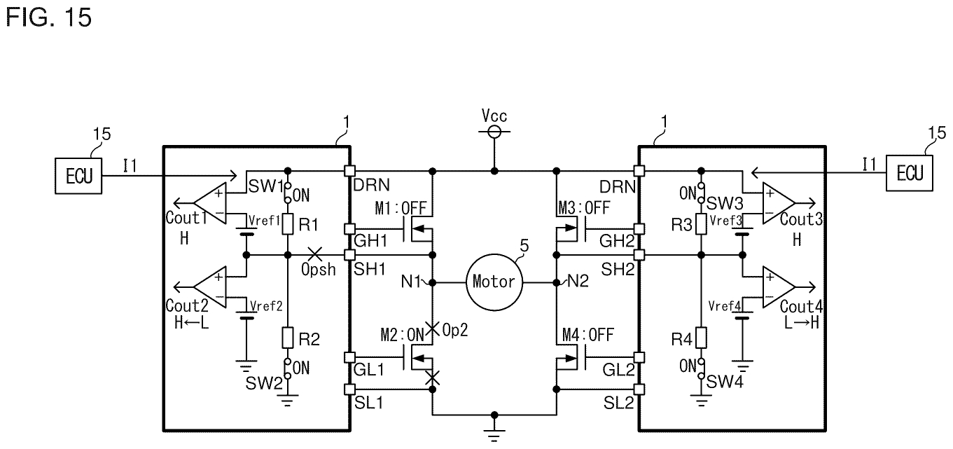

To execute open detection of the first low-side transistor M2, as shown in FIG. 15, the first low-side transistor M2 is set to on status, the other transistors M1, M3, M4 are set to off status, and all the switches SW1 to SW4 are set to on status. Given that the transistors M1 to M4 are normally functional in this state, it holds that SH1 terminal voltage=0, causing Vds1=DRN. Accordingly, Cout1 goes to high level. In this case, it holds that Vds2=0 while Cout2 goes to low level. Also, it holds, via the motor 5, that SH2 terminal voltage=0, causing Vds3=DRN and Vds4=0. Thus, it results that Cout3 goes to high level and Cout4 goes to low level.

On the other hand, when an open Op2 has occurred to the first low-side transistor M2 as shown in FIG. 15, it holds that SH1 terminal voltage=DRN/2. Accordingly, it follows that Vds1=Vds2=DRN/2, causing Cout1 and Cout2 to go to high level. In this case, it results that SH2 terminal voltage=DRN/2. Therefore, it holds that Vds3=Vds4=DRN/2, causing Cout3 and Cout4 to go to high level. Thus, by a change to high level of Cout2 and Cout4 in contrast to the normal-condition case, an open of the first low-side transistor M2 can be detected.

Also, when an open Opsh has occurred to a wiring connected to the SH1 terminal as shown in FIG. 15, Cout4 is at low level as in the normal-condition case, whereas Cout2 is changed to high level in contrast to the normal-condition case, so that the open Opsh can also be detected.

In addition, in FIG. 15, setting the first low-side transistor M2 to off status and the second low-side transistor M4 to on status allows an open of the second low-side transistor M4 to be detected. In this case, an open of a wiring connected to the SH2 terminal can also be detected.

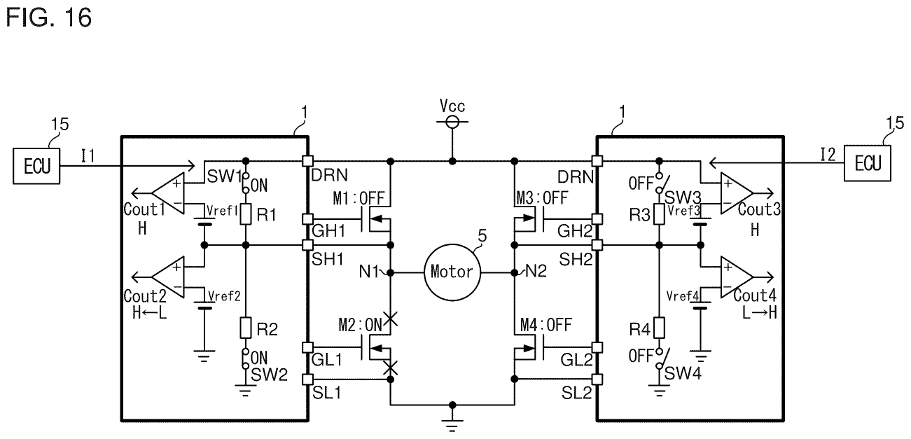

FIG. 16 is a diagram showing a modification of the open detection operation shown in FIG. 15. Here is assumed a difference from FIG. 15 that the switches SW3 and SW4 are set to off status. As a result, an open of the first low-side transistor M2 can be detected by level change of Cout2 and Cout4 as in the case of FIG. 15, whereas power consumption can be reduced. Moreover, a current flows through the application end of the power supply voltage Vcc, the voltage divider resistor R3, the SH2 terminal, the motor 5, and the first low-side transistor M2 of on status under a normal condition in FIG. 15, whereas the current is small in magnitude because of the resistance value of the voltage divider resistor R3 having been set enough larger than the resistance value of the motor 5. Therefore, operation of the motor 5 can be reduced. However, under the condition of FIG. 16, in which the voltage divider resistor R3 is set to off status, the above-mentioned current becomes zero, so that the operation of the motor 5 can be reduced to more extent.

Further, for open detection of the second low-side transistor M4, it is appropriate that, in FIG. 16, the first low-side transistor M2 is set to off status, the second low-side transistor M4 is set to on status, the switches SW1 and SW2 are set to off status, and the switches SW3 and SW4 are set to on status. Thus, a current flowing via the voltage divider resistor R1 and the motor 5 to the second low-side transistor M4 under a normal condition becomes zero, so that the operation of the motor 5 can be reduced.

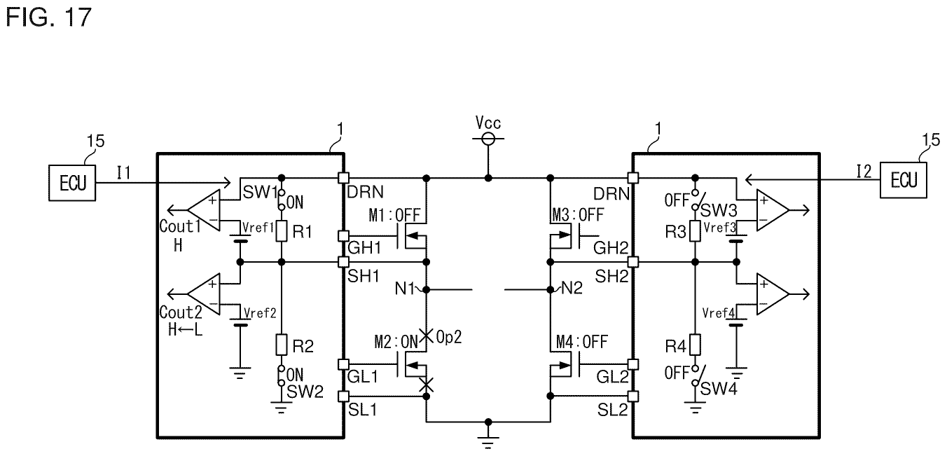

FIG. 17 is a diagram showing open detection operation of the first low-side transistor M2 under a motor 5-disconnected state. In this case, the first low-side transistor M2 is set to on status, the other transistors M1, M3, M4 are set to off status, and the switches SW1 and SW2 are set to on status. As a result, under a normal condition, Cout1 goes to high level and Cout2 goes to low level. On the other hand, when an open Op2 has occurred to the first low-side transistor M2, Cout1 and Cout2 go to high level. Therefore, by level change of Cout2 as compared with the normal-condition case, the open of the first low-side transistor M2 can be detected. In this case, as shown in FIG. 17, setting the switches SW3 and SW4 to off status allows power consumption to be reduced.

In addition, for open detection of the second low-side transistor M4, it is appropriate that, in FIG. 17, the first low-side transistor M2 is set to off status, the second low-side transistor M4 is set to on status, the switches SW3 and SW4 are set to on status, and the switches SW1 and SW2 are set to off status.

Further, an open of the transistors M1 to M4 as described above results in a state equivalent to an open (disconnection) between the GH1 terminal and the gate of the transistor M1, an open between the GL1 terminal and the gate of the transistor M2, an open between the GH2 terminal and the gate of the transistor M3, and an open between the GL2 terminal and the gate of the transistor M4. Therefore, by the above-described open detection operation, an open between the GH1 terminal and the gate of the transistor M1 or the like can also be detected.

### <5. Open Detection of Motor-Connection Wiring>

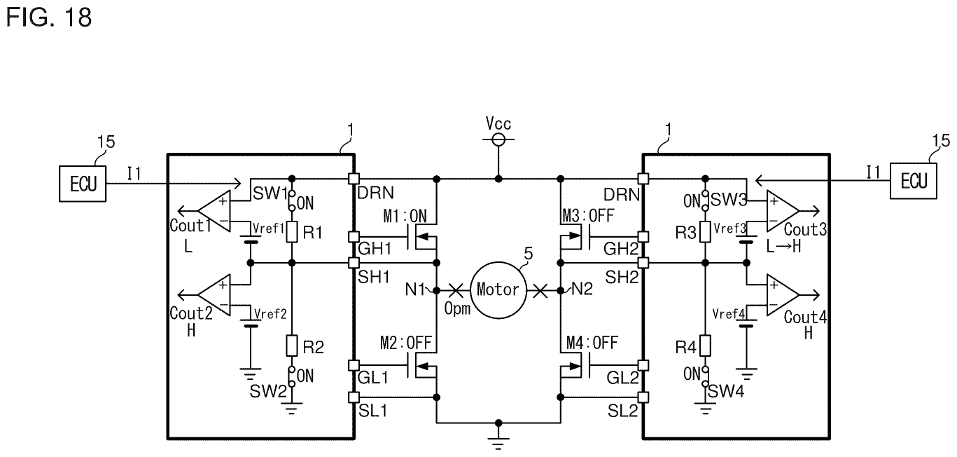

FIG. 18 is a diagram showing an operation of detecting an open of wiring that connects the motor 5. In FIG. 18, the first high-side transistor M1 is set to on status, the other transistors M2 to M4 are set to off status, and the switches SW1 to SW4 are set to on status. That is, FIG. 18 shows a state equivalent to FIG. 11 dedicated to open detection of the first high-side transistor M1.

In FIG. 18, under a normal wiring condition of the motor 5, it holds that SH1 terminal voltage=DRN, causing Vds1=0 and Vds2=DRN while Cout1 goes to low level and Cout2 goes to high level. In this case, it follows, via the motor 5, that SH2 terminal voltage=DRN, Vds3=0, and Vds4=DRN while Cout3 goes to low level and Cout4 goes to high level.

On the other hand, when an open Opm has occurred to wiring that connects the motor 5 as shown in FIG. 18, Cout1 and Cout2 are as in the normal-condition case, whereas SH2 terminal voltage=DRN/2, and Vds3=Vds4=DRN/2, so that Cout3 and Cout4 go to high level. Thus, by level change of Cout3, the open Opm can be detected.

### <6. Prime Effects>

As described hereinabove, with the motor drive device 1 according to the embodiment of the present disclosure, even under a motor 5-connected condition, various types of abnormality detection can be achieved by setting the transistors M1 to M4 into such a configuration that the motor 5 remains nonoperating. Further, abnormality detection can also be achieved with the motor 5 disconnected. Furthermore, there is no need for providing constant current sources corresponding to the transistors M1 to M4, respectively, as needed in the comparative example, so that circuit size can be reduced. In addition, although the voltage divider resistors R1 to R4 are provided, setting the switches SW1 to SW4 to off status under a normal condition allows power consumption to be reduced.

### <7. Number of Half Bridges>

Although two bridge circuits have been used in the above-described embodiment because of the use of an H-bridge circuit, this is not limitative. For example, three half bridges may be used to provide such a motor system as configured to drive a three-phase motor. Furthermore, for example, one half bridge may be used to provide such a motor system as configured to drive a brush-equipped DC motor.

### <8. Application to Vehicles>

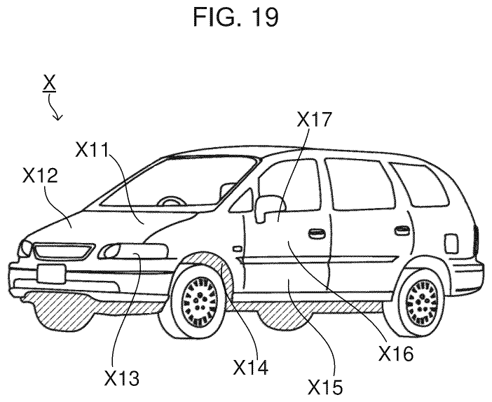

FIG. 19 is an appearance view showing a configuration example of a vehicle on which the above-described motor system 10 is mounted. FIG. 19 shows various motors X11 to X17 to be mounted on a vehicle X as an application example of the motor 5. The motor system 10 is suitable particularly for on-vehicle use that requires functional safety.

X11 denotes an electrical power steering motor. X12 denotes an electrical oil pump motor. X13 denotes a headlight drive motor. X14 denotes an electrical parking brake motor. X15 denotes a sheet cooling fan motor. X16 denotes a door opening/closing motor. X17 denotes a door lock motor.

### <9. Others>

Various technical features disclosed herein may be carried out not only along the above-described embodiment but also with changes or modifications added in various ways without deviating from the gist of technical contrivance of the disclosure. That is, the embodiment should be construed as not being limitative but being an exemplification at all points. The technical scope of the disclosure should be defined not by the above description of the embodiment but by the appended claims including all changes and modifications equivalent in sense and range to the claims.

### <10. Appendix>

As described hereinabove, according to one aspect of the present disclosure, for example, there is provided:
a motor drive device (1) configured to drive a motor by using at least one half bridge (HB1, HB2) which has a high-side transistor (M1, M3) and a low-side transistor (M2, M4) connected in series between an application end of a power supply voltage (Vcc) and an application end of ground potential and which is so configured that the motor (5) is connectable to a node (N1, N2) where the high-side transistor and the low-side transistor are connected to each other, the motor drive device comprising:
a first external terminal (DRN terminal) configured to be connectable to a first main electrode (drain) connected to the application end of the power supply voltage in the high-side transistor;
a second external terminal (SH1, SH2) configured to be connectable to a second main electrode (source) of the high-side transistor;
a transistor drive unit (1A) configured to apply a first control voltage (Gh1, Gh2) to a control end of the high-side transistor and apply a second control voltage (Gl1, Gl2) to a control end of the low-side transistor; and
an abnormality detection unit (1B), wherein
   the abnormality detection unit includes:
a first voltage divider resistor (R1, R3) connected between the first external terminal and the second external terminal;
a second voltage divider resistor (R2, R4) connected between the second external terminal and the application end of the ground potential;
a first switch (SW1, SW3) connected between the first external terminal and the second external terminal;
a second switch (SW2, SW4) connected between the second external terminal and the application end of the ground potential;
a first comparator (CP1, CP3) configured to compare a voltage between the first external terminal and the second external terminal with a first reference voltage (Vref1, Vref3); and
a second comparator (CP2, CP4) configured to compare a voltage between the second external terminal and the application end of the ground potential with a second reference voltage (Vref2, Vref4) (first configuration, FIG. 1).

In the first configuration, desirably, resistance values of the first voltage divider resistor and the second voltage divider resistor are larger than a resistance value of the motor (second configuration).

In the first or second configuration, the half bridge may be provided in plurality (third configuration).

In the third configuration, the abnormality detection unit may be configured to detect a short of the high-side transistors or a short of the low-side transistors in a state in which, with the motor connected to the node, the high-side transistors and the low-side transistors of the plural half bridges are set all to off status, and the first switches and the second switches corresponding to the plural half bridges are set all to on status (fourth configuration, FIG. 2 and FIG. 9).

Also in the third configuration, the abnormality detection unit may be configured to detect a short of the high-side transistors or a short of the low-side transistors in a state in which, with the motor connected to the node, the high-side transistors and the low-side transistors of the plural half bridges are set all to off status, the first switch and the second switch corresponding to one half bridge out of the plural half bridges are set to on status, and the first switches and the second switches corresponding to the other half bridges are set to off status (fifth configuration, FIG. 4 and FIG. 10).

Also in the third configuration, the abnormality detection unit may be configured to detect a short of the high-side transistors or a short of the low-side transistors in a state in which, with the motor unconnected to the node, the high-side transistors and the low-side transistors of the plural half bridges are set all to off status, and the first switches and the second switches corresponding to the plural half bridges are set all to on status (sixth configuration, FIG. 5 and FIG. 6).

Also in the third configuration, the abnormality detection unit may be configured to detect a short of the high-side transistors or a short of the low-side transistors in a state in which, with the motor unconnected to the node, the high-side transistors and the low-side transistors of the plural half bridges are set all to off status, the first switch and the second switch corresponding to one half bridge out of the plural half bridges are set to on status, and the first switches and the second switches corresponding to the other half bridges are set to off status (seventh configuration, FIG. 7 and FIG. 8).

Also in the third configuration, the abnormality detection unit may be configured to detect an open of the high-side transistors in a state in which, with the motor connected to the node, the high-side transistor of one half bridge out of the plural half bridges is set to on status, the low-side transistor of the one half bridge is set to off status, the high-side transistors and the low-side transistors of the other half bridges are set to off status, and the first switches and the second switches corresponding to the plural half bridges are set all to on status (eighth configuration, FIG. 11).

Also in the third configuration, the abnormality detection unit may be configured to detect an open of the high-side transistors in a state in which, with the motor connected to the node, the high-side transistor of one half bridge out of the plural half bridges is set to on status, the low-side transistor of the one half bridge is set to off status, the high-side transistors and the low-side transistors of the other half bridges are set to off status, the first switch and the second switch of the one half bridge are set to on status, and the first switches and the second switches corresponding to the other half bridges are set to off status (ninth configuration, FIG. 13).

Also in the third configuration, the abnormality detection unit may be configured to detect an open of the high-side transistors in a state in which, with the motor unconnected to the node, the high-side transistor of one half bridge out of the plural half bridges is set to on status, the low-side transistor of the one half bridge is set to off status, the high-side transistors and the low-side transistors of the other half bridges are set to off status, the first switch and the second switch corresponding to the one half bridge are set to on status, and the first switches and the second switches corresponding to the other half bridges are set to off status (tenth configuration, FIG. 14).

Also in the third configuration, the abnormality detection unit may be configured to detect an open of the low-side transistors in a state in which, with the motor connected to the node, the low-side transistor of one half bridge out of the plural half bridges is set to on status, the high-side transistor of the one half bridge is set to off status, the high-side transistors and the low-side transistors of the other half bridges are set to off status, and the first switches and the second switches corresponding to the plural half bridges are set all to on status (eleventh configuration, FIG. 15).

Also in the third configuration, the abnormality detection unit may be configured to detect an open of the low-side transistors in a state in which, with the motor connected to the node, the low-side transistor of one half bridge out of the plural half bridges is set to on status, the high-side transistor of the one half bridge is set to off status, the high-side transistors and the low-side transistors of the other half bridges are set to off status, the first switch and the second switch of the one half bridge are set to on status, and the first switches and the second switches corresponding to the other half bridges are set to off status (twelfth configuration, FIG. 16).

Also in the third configuration, the abnormality detection unit may be configured to detect an open of the low-side transistors in a state in which, with the motor unconnected to the node, the low-side transistor of one half bridge out of the plural half bridges is set to on status, the high-side transistor of the one half bridge is set to off status, the high-side transistors and the low-side transistors of the other half bridges are set to off status, the first switch and the second switch of the one half bridge are set to on status, and the first switches and the second switches corresponding to the other half bridges are set to off status (thirteenth configuration, FIG. 17).

Also in the third configuration, the abnormality detection unit may be configured to detect an open of wiring for connection of the motor to the node in a state in which, with the motor connected to the node, the high-side transistor of one half bridge out of the plural half bridges is set to on status, the low-side transistor of the one half bridge is set to off status, the high-side transistors and the low-side transistors of the other half bridges are set to off status, and the first switches and the second switches corresponding to the plural half bridges are set all to on status (fourteenth configuration, FIG. 18).

According to one aspect of the disclosure, there is provided a motor system (10) comprising: the motor drive device (1) according to any one of the third to fourteenth configurations; an H-bridge circuit (HC) including two foregoing half bridges (HB1, HB2); and the motor (5) (fifteenth configuration, FIG. 1).

According to one aspect of the disclosure, there is provided a motor system (10) comprising: the motor drive device (1) according to any one of the first to fourteenth configurations; the half bridge (HB1, HB2); and the motor (5) (sixteenth configuration, FIG. 1).

According to one aspect of the disclosure, there is provided a vehicle (X) comprising the motor system (10) of the sixteenth configuration (seventeenth configuration, FIG. 19).

### INDUSTRIAL APPLICABILITY

The present disclosure is utilizable for, for example, on-vehicle motor systems.

### REFERENCE SIGNS LIST

1 motor drive device
1A transistor drive unit
1B abnormality detection unit
5 motor
10 motor system
50 motor
100 motor drive device
200 motor system
AP1 to AP4 amplifier
C1 to C4 constant current source
CP1 to CP4 comparator
D1 to D4 diode
HB1 first half bridge
HB2 second half bridge
HC H-bridge circuit
M1 first high-side transistor
M2 first low-side transistor
M3 second high-side transistor
M4 second low-side transistor
N1 first node
N2 second node
R1 to R4 voltage divider resistor
SW1 to SW4 switch
X vehicle

1. A motor drive device configured to drive a motor by using at least one half bridge which has a high-side transistor and a low-side transistor connected in series between an application end of a power supply voltage and an application end of ground potential and which is so configured that the motor is connectable to a node where the high-side transistor and the low-side transistor are connected to each other, the motor drive device comprising:
a first external terminal configured to be connectable to a first main electrode connected to the application end of the power supply voltage in the high-side transistor;
a second external terminal configured to be connectable to a second main electrode of the high-side transistor;
a transistor drive unit configured to apply a first control voltage to a control end of the high-side transistor and apply a second control voltage to a control end of the low-side transistor; and
an abnormality detection unit, wherein
the abnormality detection unit includes:
a first voltage divider resistor connected between the first external terminal and the second external terminal;
a second voltage divider resistor connected between the second external terminal and the application end of the ground potential;
a first switch connected between the first external terminal and the second external terminal;
a second switch connected between the second external terminal and the application end of the ground potential;
a first comparator configured to compare a voltage between the first external terminal and the second external terminal with a first reference voltage; and
a second comparator configured to compare a voltage between the second external terminal and the application end of the ground potential with a second reference voltage.

2. The motor drive device according to claim 1, wherein resistance values of the first voltage divider resistor and the second voltage divider resistor are larger than a resistance value of the motor.

3. The motor drive device according to claim 1, wherein
the half bridge is provided in plurality.

4. The motor drive device according to claim 3, wherein
the abnormality detection unit is configured to detect a short of the high-side transistors or a short of the low-side transistors in a state in which, with the motor connected to the node, the high-side transistors and the low-side transistors of the plural half bridges are set all to off status, and the first switches and the second switches corresponding to the plural half bridges are set all to on status.

5. The motor drive device according to claim 3, wherein
the abnormality detection unit is configured to detect a short of the high-side transistors or a short of the low-side transistors in a state in which, with the motor connected to the node, the high-side transistors and the low-side transistors of the plural half bridges are set all to off status, the first switch and the second switch corresponding to one of the half bridges are set to on status, and the first switches and the second switches corresponding to the other half bridges are set to off status.

6. The motor drive device according to claim 3, wherein the abnormality detection unit is configured to detect a short of the high-side transistors or a short of the low-side transistors in a state in which, with the motor unconnected to the node, the high-side transistors and the low-side transistors of the plural half bridges are set all to off status, and the first switches and the second switches corresponding to the plural half bridges are set all to on status.

7. The motor drive device according to claim 3, wherein the abnormality detection unit is configured to detect a short of the high-side transistors or a short of the low-side transistors in a state in which, with the motor unconnected to the node, the high-side transistors and the low-side transistors of the plural half bridges are set all to off status, the first switch and the second switch corresponding to one of the half bridges are set to on status, and the first switches and the second switches corresponding to the other half bridges are set to off status.

8. The motor drive device according to claim 3, wherein the abnormality detection unit is configured to detect an open of the high-side transistors in a state in which, with the motor connected to the node, the high-side transistor of one half bridge out of the plural half bridges is set to on status, the low-side transistor of the one half bridge is set to off status, the high-side transistors and the low-side transistors of the other half bridges are set to off status, and the first switches and the second switches corresponding to the plural half bridges are set all to on status.

9. The motor drive device according to claim 3, wherein the abnormality detection unit is configured to detect an open of the high-side transistors in a state in which, with the motor connected to the node, the high-side transistor of one half bridge out of the plural half bridges is set to on status, the low-side transistor of the one half bridge is set to off status, the high-side transistors and the low-side transistors of the other half bridges are set to off status, the first switch and the second switch of the one half bridge are set to on status, and the first switches and the second switches corresponding to the other half bridges are set to off status.

10. The motor drive device according to claim 3, wherein the abnormality detection unit is configured to detect an open of the high-side transistors in a state in which, with the motor unconnected to the node, the high-side transistor of one half bridge out of the plural half bridges is set to on status, the low-side transistor of the one half bridge is set to off status, the high-side transistors and the low-side transistors of the other half bridges are set to off status, the first switch and the second switch corresponding to the one half bridge are set to on status, and the first switches and the second switches corresponding to the other half bridges are set to off status.

11. The motor drive device according to claim 3, wherein the abnormality detection unit is configured to detect an open of the low-side transistors in a state in which, with the motor connected to the node, the low-side transistor of one half bridge out of the plural half bridges is set to on status, the high-side transistor of the one half bridge is set to off status, the high-side transistors and the low-side transistors of the other half bridges are set to off status, and the first switches and the second switches corresponding to the plural half bridges are set all to on status.

12. The motor drive device according to claim 3, wherein the abnormality detection unit is configured to detect an open of the low-side transistors in a state in which, with the motor connected to the node, the low-side transistor of one half bridge out of the plural half bridges is set to on status, the high-side transistor of the one half bridge is set to off status, the high-side transistors and the low-side transistors of the other half bridges are set to off status, the first switch and the second switch of the one half bridge are set to on status, and the first switches and the second switches corresponding to the other half bridges are set to off status.

13. The motor drive device according to claim 3, wherein the abnormality detection unit is configured to detect an open of the low-side transistors in a state in which, with the motor unconnected to the node, the low-side transistor of one half bridge out of the plural half bridges is set to on status, the high-side transistor of the one half bridge is set to off status, the high-side transistors and the low-side transistors of the other half bridges are set to off status, the first switch and the second switch of the one half bridge are set to on status, and the first switches and the second switches corresponding to the other half bridges are set to off status.

14. The motor drive device according to claim 3, wherein the abnormality detection unit is configured to detect an open of wiring for connection of the motor to the node in a state in which, with the motor connected to the node, the high-side transistor of one half bridge out of the plural half bridges is set to on status, the low-side transistor of the one half bridge is set to off status, the high-side transistors and the low-side transistors of the other half bridges are set to off status, and the first switches and the second switches corresponding to the plural half bridges are set all to on status.

15. A motor system comprising:
the motor drive device according to claim 3;
an H-bridge circuit including two foregoing half bridges; and
the motor.

16. A motor system comprising:
the motor drive device according to claim 1;
the half bridge; and
the motor.

17. A vehicle comprising the motor system according to claim 16.
